(19) United States
(12) Patent Application Publication
(10) Pub. No.: US 2024/0033824 A1
(43) Pub. Date: Feb. 1, 2024

(54) MANUFACTURING METHOD

(71) Applicant: RENISHAW PLC, Wotton-under-Edge, Gloucestershire (GB)

(72) Inventors: Mathieu BROCHU, Montreal (CA); Tejas RAMAKRISHNAN, Montreal (CA); Sunyong KWON, Montreal (CA)

(73) Assignee: RENISHAW PLC, Wotton-under-Edge, Gloucestershire (GB)

(21) Appl. No.: 18/265,785

(22) PCT Filed: Dec. 8, 2021
(86) PCT No.: PCT/GB2021/053206

§ 371 Date: Jun. 7, 2023

(30) Foreign Application Priority Data
Dec. 9, 2020 (GB) 2019374.4

(51) Int. Cl. B22F 10/28; B22F 10/50; B33Y 10/00; B33Y 40/10; C22C 27/04; B33Y 70/00

(52) U.S. Cl. CPC B22F 10/28; B22F 10/50; B33Y 10/00; B33Y 40/10; C22C 27/04; B33Y 70/00; B22F 2998/10; B22F 2201/02; B22F 2201/10; B22F 2201/03; B22F 2999/00; B22F 2301/20

(57) ABSTRACT

A method produces a workpiece including molybdenum, or tungsten, or chromium, or molybdenum alloy, or tungsten alloy, or chromium alloy by selective consolidation of successive layers of powder by an energy beam. The method includes performing the selective consolidation of the powder layer in a protective atmosphere including nitrogen.

The present invention relates to the manufacture of metal articles, more specifically the manufacture of metal articles by additive manufacturing techniques. In particular, the invention relates to the manufacture of metal articles by an additive manufacturing technique that may involve the selective melting or sintering of a metal powder. Examples of such techniques may include selective laser melting (SLM), selective laser sintering (SLS) and techniques that use an electron beam rather than a laser. These techniques can also be referred to as laser powder bed fusion (LPBF) techniques.

Selective laser melting (SLM) is a rapid prototyping (RP) and/or rapid manufacturing (RM) technology which may be used for the production of metallic solid and porous articles. Conveniently, the articles may have suitable properties to be put straight in to use. For instance, SLM may be used to produce one-off articles such as parts or components which are bespoke to their intended application. Similarly, SLM may be used to produce large or small batches of articles such as parts or components for a specific application.

SLM builds articles in a layer-by-layer fashion. Typically, this requires thin (e.g. from 20 μm to 100 μm) uniform layers of fine metal powders to be deposited on a moving substrate. The powder particles are then fused together by selectively laser scanning them, usually according to a model's 3D CAD data.

SLM relies on converting a powder into a melt pool, from which material solidifies to form a new solid component. The solid weld bead must also fuse to the underlying and surrounding solid if a dense, strong component is to be produced.

An advantage of SLM, particularly in comparison with powder sintering used in some other RP/RM processes, is complete metal powder melting which may lead to higher densities and better mechanical properties. Further, this may reduce or even eliminate the need for binders and/or for post-processing.

In addition, additive manufacturing techniques such as SLM or SLS typically may be more cost effective and/or time effective for making articles having more complex geometries when compared with conventional manufacturing techniques, due to the absence of any tooling. There may also be a significant reduction in design constraints. The production of fully functional parts directly from metal powders that can be used in place of parts that would normally be machined or cast is one reason for the widening application of additive manufacturing techniques such as SLM or SLS, e.g. in the medical, dental, aerospace and electronics sectors.

The production of articles using additive manufacturing techniques such as SLM or SLS often requires the use of fine powders of reactive metals. These powders can present significant handling problems, both from a safety perspective and from a materials processing perspective. One such safety issue relates to the possibility of explosions of fine powders when in the presence of certain reactive gases, for example oxygen present in air, especially when heated. Typically, therefore, processing of these powders is carried out used under protective atmospheres. U.S. Pat. No. 6,215,093 discloses the use of Helium, Argon, and Nitrogen atmospheres.

SLM has been used to produce 100% dense stainless steel and titanium parts and these parts typically can reliably reproduce the properties of bulk materials.

However, SLM has yet to work as well with Molybdenum, and alloys containing Molybdenum. In particular, it is difficult to manufacture Molybdenum or Molybdenum alloy articles having densities approaching 100% theoretical density.

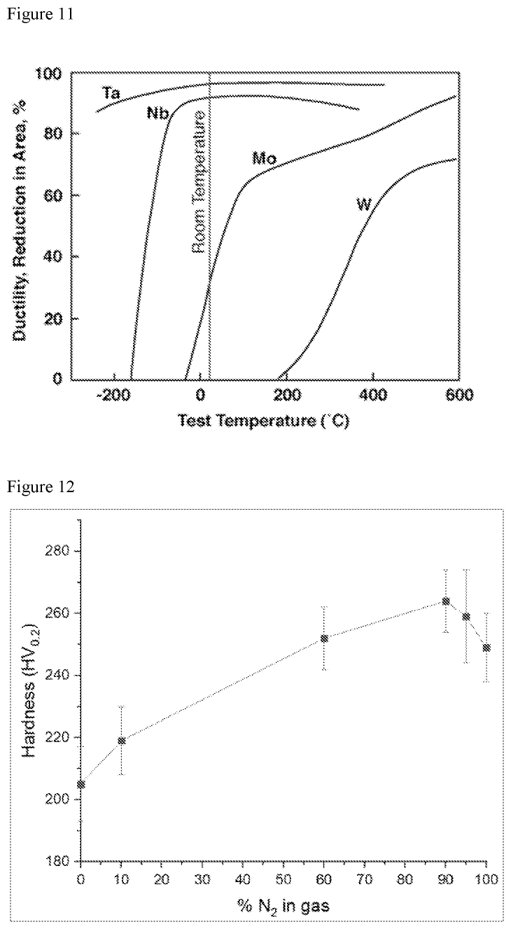

Molybdenum is a refactory metal which has not been widely employed in the fabrication of complex parts, at least in part due to its inherent brittleness at room temperature. Molybdenum is sensitive to intergranular cracking, which can occur due to the lack of ductility in the material when a thermal cycle around the ductile-to-brittle transition temperature (DBTT) is imposed which can be derived from FIG. 11. At commercial purity levels, DBTT of Molybdenum is between 323 K to 373 K (50° C. to 100° C.). The interstitial impurity content remains a major factor affecting the DBTT of Molybdenum. The presence of interstitial elements increases the DBTT of Molybdenum to above room temperature, with Oxygen showing the greatest embrittling effect through diffusion to, and weakening of, grain boundary regions.

LPBF investigations performed have shown densification to around 82.5% of the theoretical density (TD). Simulations have studied the influence of powder characteristics and proposed that smaller melt pool size causes the process to be more sensitive to the morphological characteristics of the powder bed. They proposed that the high melting point leads to small melt pool sizes, and this varies widely with powder bed density. Densification has also been shown to 99.1% through dry granulation along with plasma spheroidization of Molybdenum powders, and crack suppression by using support structures capable to keep a low cooling rate and maintaining high temperature during the build (reported above 200° C.) from the usage of thin support structure and significant powder underneath the part limiting heat conduction. The crack formation in pure Molybdenum has been ascribed to the Oxygen content coming from contamination on the powder surface and pick up during processing, which segregated to the grain boundaries and caused embrittlement.

Tungsten is another refactory metal found in the same group of the Periodic Table as Molybdenum. The DBTT for Tungsten is reported as being 400° C. (as can be seen in FIG. 11). Tungsten also shows an increase in brittleness below its DBTT. When producing Tungsten parts using LPBF, it is known to preheat the powder to temperatures in excess of the DBTT (typically 600 to 800° C.) in order to obtain crack free parts.

Chromium is a further refactory metal found in the same group of the Periodic Table as Molybdenum and Tungsten.

According to a first aspect of invention there is provided a method of producing a workpiece comprising Molybdenum, or Tungsten, or Chromium, or Molybdenum alloy, or Tungsten alloy, or Chromium alloy by selective consolidation of successive layers of powder by an energy beam, the method comprising performing the selective consolidation of the powder layer in a protective atmosphere comprising Nitrogen.

It will be understood that a tungsten alloy is an alloy where tungsten is the principal element, i.e. the most abundant element either by weight or by stoichiometry. Tungsten alloy also covers alloys comprising a binary system of tungsten and another element, where each element of the binary system is the (joint) most abundant element (either by weigh or stoichiometry) of the alloy (for the avoidance of doubt, a binary system may comprise further elements). A tungsten alloy may comprise at least 45% tungsten by weight, optionally at least 50% by weight.

It will be understood that a molybdenum alloy is an alloy where molybdenum is the principal element, i.e. the most abundant element either by weight or by stoichiometry. Molybdenum alloy also covers alloys comprising a binary system of molybdenum and another element, where each element of the binary system is the (joint) most abundant element (either by weigh or stoichiometry) of the alloy (for the avoidance of doubt, a binary system may comprise further elements e.g. a binary system of Mo and Cu comprising at least one of Ni, Co, and Fe in an amount of 0.1 to 3% by mass in terms of metal element). A molybdenum alloy may comprise at least 45% molybdenum by weight, optionally at least 50% by weight.

It will be understood that a chromium alloy is an alloy where chromium is the principal element, i.e. the most abundant element either by weight or by stoichiometry. Chromium alloy also covers alloys comprising a binary system of chromium and another element, where each element of the binary system is the (joint) most abundant element (either by weigh or stoichiometry) of the alloy (for the avoidance of doubt, a binary system may comprise further elements). A chromium alloy may comprise at least 45% chromium by weight, optionally at least 50% by weight.

The tungsten alloy, or the molybdenum alloy, or the chromium alloy may be an alloy comprising a BCC crystal structure.

The oxygen concentration in the protective atmosphere may be less than 1000 ppm, optionally less than 900 ppm, optionally less than 800 ppm, optionally less than 700 ppm, optionally less than 600 ppm, optionally less than 500 ppm, optionally less than 400 ppm, optionally less than 300 ppm, optionally less than 200 ppm, optionally less than 100 ppm.

Optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the oxygen concentration in the protective atmosphere may be less than 1000 ppm, optionally less than 500 ppm.

In some embodiments it may be desirable to have a protective atmosphere substantially comprising of Nitrogen. In these embodiments Nitrogen having a purity of 99.998% may be used and a protective atmosphere having up to 99.998% Nitrogen may be achieved, in other embodiments having a protective atmosphere substantially comprising Nitrogen protective atmosphere having 99.99% Nitrogen, 99.95% Nitrogen, 99.9% Nitrogen, or 99.8% may be achieved.

The protective atmosphere may comprise at least 5% Argon by volume, optionally at least 10%, optionally at least 20%, optionally at least 30%, optionally at least 40%, optionally at least 50%, optionally at least 60%.

In some embodiments it may be desirable for the protective atmosphere to comprise Nitrogen and a noble gas, for example Argon. In these embodiments the protective atmosphere may comprise substantially 5% Argon (or more) and substantially 95% Nitrogen (or less) while Oxygen content of the protective atmosphere does not exceed 1000 ppm optionally 500 ppm. Optionally 5% to 30% Argon may be present in the protective atmosphere, with the remainder being substantially Nitrogen.

The protective atmosphere may comprise by volume ten times the amount of Nitrogen relative to the amount of Oxygen, optionally 25 times the amount of Nitrogen relative to the amount of Oxygen.

By consolidating powder in a protective atmosphere comprising Nitrogen cracking may be reduced or even eliminated.

Optionally the layer of powder comprises molybdenum, or tungsten or molybdenum alloy, or tungsten alloy powder.

Optionally the layer of powder comprises Molybdenum powder, or Tungsten powder, or Chromium powder, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the Oxygen concentration in the protective atmosphere may be less than 1000 ppm, optionally less than 500 ppm.

Optionally the layer of powder comprises Molybdenum alloy powder or Tungsten alloy powder, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the Oxygen concentration in the protective atmosphere may be less than 1000 ppm, optionally less than 500 ppm.

The Molybdenum alloy may comprise by weight 25% Molybdenum, 5% Chromium, up to 2% Iron, up to 1% Cobalt, up to 0.8% Manganese, up to 0.8% Silicon, up to 0.5% Aluminium, up to 0.03% Carbon, up to 0.006% Boron, and a balance of Nickel, optionally the protective atmosphere may comprise nitrogen and a further protective gas, for example a noble gas such as Argon or Helium, volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the Oxygen concentration in the protective atmosphere may be less than 1000 ppm, optionally less than 500 ppm.

The Molybdenum alloy may comprise 40 to 180 ppm Aluminium, 600 to 2500 ppm Silicon, 50 to 150 ppm Potassium, and a balance of Molybdenum, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the Oxygen concentration in the protective atmosphere may be less than 1000 ppm, optionally less than 500 ppm.

The Molybdenum alloy may be Molybdenum-Lanthanum and may comprise Molybdenum doped with La₂O₃, and my optionally comprise at least 99.00% Molybdenum and up to 0.875% La₂O₃, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the Oxygen concentration in the protective atmosphere may be less than 1000 ppm, optionally less than 500 ppm.

The Molybdenum alloy may comprise Molybdenum and 30% Copper, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the Oxygen concentration in the protective atmosphere may be less than 1000 ppm, optionally less than 500 ppm.

The Molybdenum alloy may be a binary system of Mo and Cu, but may contain at least one of Ni, Co, and Fe in an amount of 0.1 to 3% by mass in terms of metal element, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the Oxygen concentration in the protective atmosphere may be less than 1000 ppm, optionally less than 500 ppm.

The Molybdenum alloy may be a TZM alloy, optionally comprising, by weight, 0.08% Zirconium, 0.5% titanium, 0.03% Carbon, and a balance of Molybdenum, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the Oxygen concentration in the protective atmosphere may be less than 1000 ppm, optionally less than 500 ppm.

The Molybdenum alloy may be HCT Molybdenum and optionally comprises at least 99.90% Molybdenum and up to 150 ppm Potassium, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the Oxygen concentration in the protective atmosphere may be less than 1000 ppm, optionally less than 500 ppm.

The Molybdenum alloy may comprise a Molybdenum Niobium allow and optionally comprises a 1:1 ratio by weight of Molybdenum and Niobium, alternatively a 9:1 ratio by weight of Molybdenum and Niobium, alternatively a 19:1 ratio by weight of Molybdenum and Niobium, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the Oxygen concentration in the protective atmosphere may be less than 1000 ppm, optionally less than 500 ppm.

The Tungsten alloy may comprise 97% Tungsten and 3% Rhenium, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the Oxygen concentration in the protective atmosphere may be less than 1000 ppm, optionally less than 500 ppm.

The Tungsten alloy may comprise a Tungsten Copper alloy and may comprise 10% Copper with the balance Tungsten, alternatively may comprise 15% Copper with the balance Tungsten, alternatively may comprise 20% Copper with the balance Tungsten, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally more than 60%, optionally more than 70%, optionally 50% to 60%, optionally the Oxygen concentration in the protective atmosphere may be less than 1000 ppm, optionally less than 500 ppm.

The Tungsten alloy may comprise a Tungsten—Potassium alloy and optionally comprises between 6*10⁻⁴ and 6.5*10⁻⁴% Potassium, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the Oxygen concentration in the protective atmosphere may be less than 1000 ppm, optionally less than 500 ppm.

The Tungsten alloy may be a WHA alloy (Tungsten Heavy Alloy), optionally comprising from 89% to 97% Tungsten with a balance of Nickel and Iron, optionally the ratio of Nickel to Iron is 3:1 by weight, alternatively the ratio of Nickel to Iron is 7:1 by weight, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the Oxygen concentration in the protective atmosphere may be less than 1000 ppm, optionally less than 500 ppm.

The Tungsten alloy may comprise from 0.5% to 1.5% La₂O₃, and a balance of Tungsten, optionally the protective atmosphere may comprise nitrogen and a further protective gas, for example a noble gas such as Argon or Helium, volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the Oxygen concentration in the protective atmosphere may be less than 1000 ppm, optionally less than 500 ppm.

Optionally the layer of powder comprises Molybdenum powder or Tungsten powder, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the protective atmosphere comprises by volume ten times the amount of Nitrogen relative to the amount of Oxygen, optionally 25 times the amount of Nitrogen relative to the amount of Oxygen.

Optionally the layer of powder comprises Chromium powder, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the protective atmosphere comprises by volume ten times the amount of Nitrogen relative to the amount of Oxygen, optionally 25 times the amount of Nitrogen relative to the amount of Oxygen.

Optionally the layer of powder comprises Molybdenum alloy powder or Tungsten alloy powder, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the protective atmosphere comprises by volume ten times the amount of Nitrogen relative to the amount of Oxygen, optionally 25 times the amount of Nitrogen relative to the amount of Oxygen.

Optionally the layer of powder comprises Chromium alloy powder, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the protective atmosphere comprises by volume ten times the amount of Nitrogen relative to the amount of Oxygen, optionally 25 times the amount of Nitrogen relative to the amount of Oxygen.

The Molybdenum alloy may comprise 40 to 180 ppm Aluminium, 600 to 2500 ppm Silicon, 50 to 150 ppm Potassium, and a balance of Molybdenum, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the protective atmosphere comprises by volume ten times the amount of Nitrogen relative to the amount of Oxygen, optionally 25 times the amount of Nitrogen relative to the amount of Oxygen.

The Molybdenum alloy may be Molybdenum-Lanthanum and may comprise Molybdenum doped with La₂O₃, and my optionally comprise at least 99.00% Molybdenum and up to 0.875% La₂O₃, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the protective atmosphere comprises by volume ten times the amount of Nitrogen relative to the amount of Oxygen, optionally 25 times the amount of Nitrogen relative to the amount of Oxygen.

The Molybdenum alloy may comprise Molybdenum and 30% Copper, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the protective atmosphere comprises by volume ten times the amount of Nitrogen relative to the amount of Oxygen, optionally 25 times the amount of Nitrogen relative to the amount of Oxygen.

The Molybdenum alloy may be a binary system of Mo and Cu, but may contain at least one of Ni, Co, and Fe in an amount of 0.1 to 3% by mass in terms of metal element, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the protective atmosphere comprises by volume ten times the amount of Nitrogen relative to the amount of Oxygen, optionally 25 times the amount of Nitrogen relative to the amount of Oxygen.

The Molybdenum alloy may be a TZM alloy, optionally comprising, by weight, Zirconium, 0.5% titanium, 0.03% Carbon, and a balance of Molybdenum, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the protective atmosphere comprises by volume ten times the amount of Nitrogen relative to the amount of Oxygen, optionally 25 times the amount of Nitrogen relative to the amount of Oxygen.

The Molybdenum alloy may be HCT Molybdenum and optionally comprises at least 99.90% Molybdenum and up to 150 ppm Potassium, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the protective atmosphere comprises by volume ten times the amount of Nitrogen relative to the amount of Oxygen, optionally 25 times the amount of Nitrogen relative to the amount of Oxygen.

The Molybdenum alloy may comprise a Molybdenum Niobium allow and optionally comprises a 1:1 ratio by weight of Molybdenum and Niobium, alternatively a 9:1 ratio by weight of Molybdenum and Niobium, alternatively a 19:1 ratio by weight of Molybdenum and Niobium, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the protective atmosphere comprises by volume ten times the amount of Nitrogen relative to the amount of Oxygen, optionally 25 times the amount of Nitrogen relative to the amount of Oxygen.

The Tungsten alloy may comprise 97% Tungsten and 3% Rhenium, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the protective atmosphere comprises by volume ten times the amount of Nitrogen relative to the amount of Oxygen, optionally 25 times the amount of Nitrogen relative to the amount of Oxygen.

The Tungsten alloy may comprise a Tungsten Copper alloy and may comprise 10% Copper with the balance Tungsten, alternatively may comprise 15% Copper with the balance Tungsten, alternatively may comprise 20% Copper with the balance Tungsten, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the protective atmosphere comprises by volume ten times the amount of Nitrogen relative to the amount of Oxygen, optionally 25 times the amount of Nitrogen relative to the amount of Oxygen.

The Tungsten alloy may comprise a Tungsten—Potassium alloy and optionally comprises between 6*10-4 and 6.5*10-4% Potassium, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the protective atmosphere comprises by volume ten times the amount of Nitrogen relative to the amount of Oxygen, optionally 25 times the amount of Nitrogen relative to the amount of Oxygen.

The Tungsten alloy may be a WHA alloy (Tungsten Heavy Alloy), optionally comprising from 89% to 97% Tungsten with a balance of Nickel and Iron, optionally the ratio of Nickel to Iron is 3:1 by weight, alternatively the ratio of Nickel to Iron is 7:1 by weight, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the protective atmosphere comprises by volume ten times the amount of Nitrogen relative to the amount of Oxygen, optionally 25 times the amount of Nitrogen relative to the amount of Oxygen.

The Tungsten alloy may comprise from 0.5% to 1.5% La₂O₃, and a balance of Tungsten, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the protective atmosphere comprises by volume ten times the amount of Nitrogen relative to the amount of Oxygen, optionally 25 times the amount of Nitrogen relative to the amount of Oxygen.

The Chromium alloy may be ferrochrome comprising 50% to 70% by weight chromium and a balance of iron, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%, optionally the protective atmosphere comprises by volume ten times the amount of Nitrogen relative to the amount of Oxygen, optionally 25 times the amount of Nitrogen relative to the amount of Oxygen.

Optionally the powder layer is preheated to a maximum temperature not exceeding the ductile to brittle transition temperature of the powder.

The powder layer may be preheated to a maximum temperature not exceeding 400° C., optionally not exceeding 350° C., optionally not exceeding 300° C., optionally not exceeding 250° C., optionally not exceeding 200° C., optionally not exceeding 150° C., optionally not exceeding 100° C., optionally not exceeding 90° C., optionally not exceeding 80° C.

The powder layer may be preheated in the range 80° C. to 400° C. Optionally the powder comprises a Tungsten or Tungsten alloy and the powder layer is preheated in the range 80° C. to 400° C.

Optionally the powder layer is preheated in the range 80° C. to the ductile to brittle transition temperature of the powder.

By reducing or eliminating the need for preheating of the powder prior to consolidation with the energy beam cooling of a part take less time which can decrease the amount of time required for a particular build. Reducing or eliminating the need for preheating of the powder prior to consolidation with the energy beam can also allow builds to be carried out using machines without the preheating capacity, such machines can therefore be simpler, easier to assemble, require fewer parts, or be cheaper.

Optionally the object is produced using a raster scan strategy, for example with a 67° rotation between layers. Alternatively, the object may be produced using a vector scan strategy.

Performing a build in a protective atmosphere comprising Nitrogen can allow a crack density of less than 0.8/mm², optionally less than 0.6/mm², optionally less than 0.4/mm², optionally less than 0.2/mm².

Performing a build in a protective atmosphere comprising Nitrogen can allow an average crack length of less than 800 μm, optionally less than 600 μm, optionally less than 400 μm, optionally less than 200 μm, optionally less than 100 μm.

Optionally the density of the part is at least 99%. According to a second aspect of invention there is provided a method of producing a workpiece comprising Molybdenum or Molybdenum alloy by selective consolidation of successive layers of powder by an energy beam, the method comprising performing the selective consolidation of the powder layer in a protective atmosphere comprising Nitrogen, optionally the oxygen concentration of the atmosphere may be less than 1000 ppm, optionally less than 500 ppm during the build, optionally the protective atmosphere may comprise nitrogen and a further protective gas, for example a noble gas such as Argon or Helium, optionally the protective atmosphere may comprise at least 5% Nitrogen by volume, optionally the protective atmosphere may comprise Nitrogen by volume in the range 6% to 99.998%, optionally 7% to 99.99% optionally 99.95%, optionally 8% to 99.9%, optionally 9% to 99.8%, optionally 10% to 95%, optionally 20% to 90%, optionally 30% to 80%, optionally 40% to 70%, optionally 50% to 60%, optionally more than 60%, optionally more than 70%. The method may produce a part (or parts) having a crack density of less than 0.4/mm², and may have an average crack length of less than 400 μm.

According to a third aspect of invention there is provided a method of producing a workpiece comprising Tungsten or Tungsten alloy by selective consolidation of successive layers of powder by an energy beam, the method comprising performing the selective consolidation of the powder layer in a protective atmosphere comprising Nitrogen. The powder layer may be pre-heated to a temperature not exceeding 200° C., optionally not exceeding 100° C. The oxygen concentration of the protective atmosphere may be less than 1000 ppm, optionally less than 500 ppm during the build. The method may produce a part (or parts) having a crack density of less than 0.4/mm², and may have an average crack length of less than 400 μm.

Features from one aspect of invention are applicable to other aspects of invention.

The invention will now be described, by way of example only, with reference to the accompanying drawings, in which:

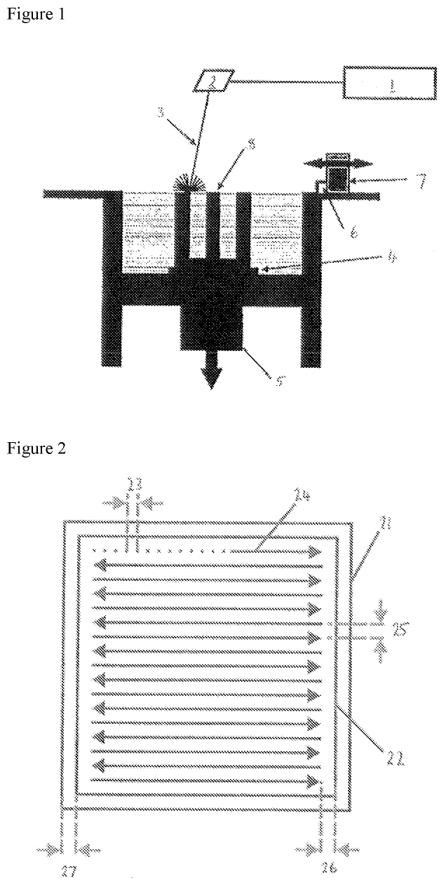

FIG. 1 illustrates a typical SLM process and apparatus;

FIG. 2 illustrates some of the main laser scanning parameters;

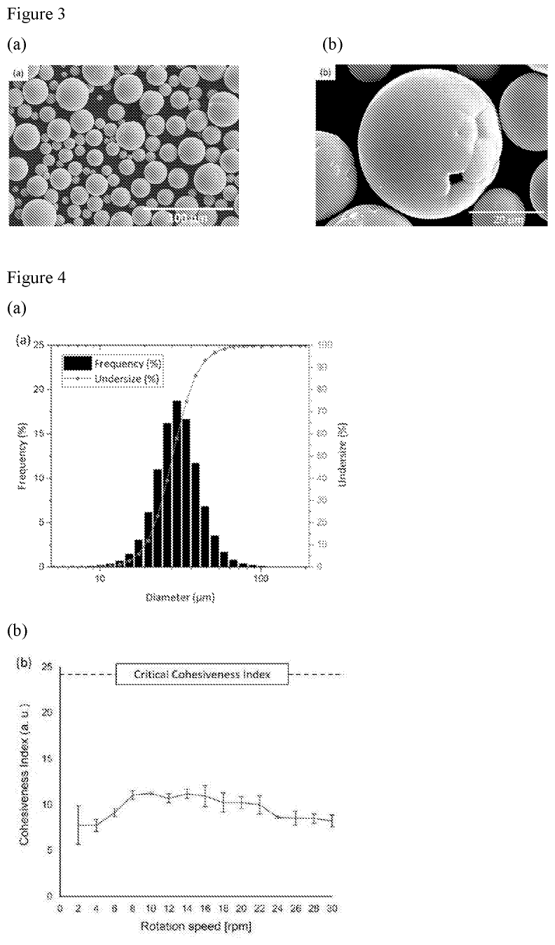

FIG. 3 shows SEM images of Mo powders showing (a) size and shape (b) morphology of the particles;

FIG. 4 shows (a) particle size distribution, and (b) cohesiveness index with respect to rotation speed, for Mo powder;

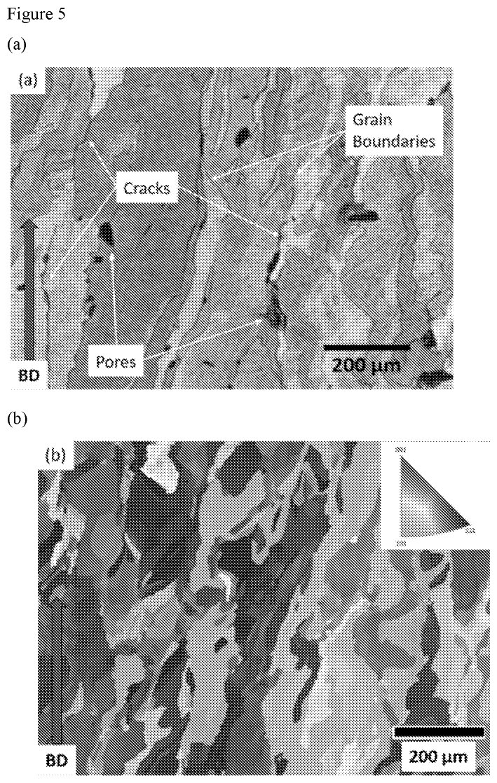

FIG. 5 shows (a) optical, and (b) EBSD micrograph of Mo—Ar sample;

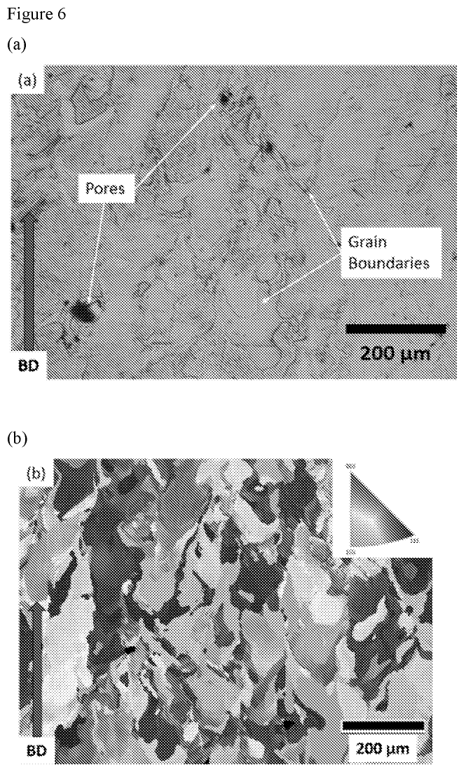

FIG. 6 shows (a) optical, and (b) EBSD micrograph of Mo—N sample;

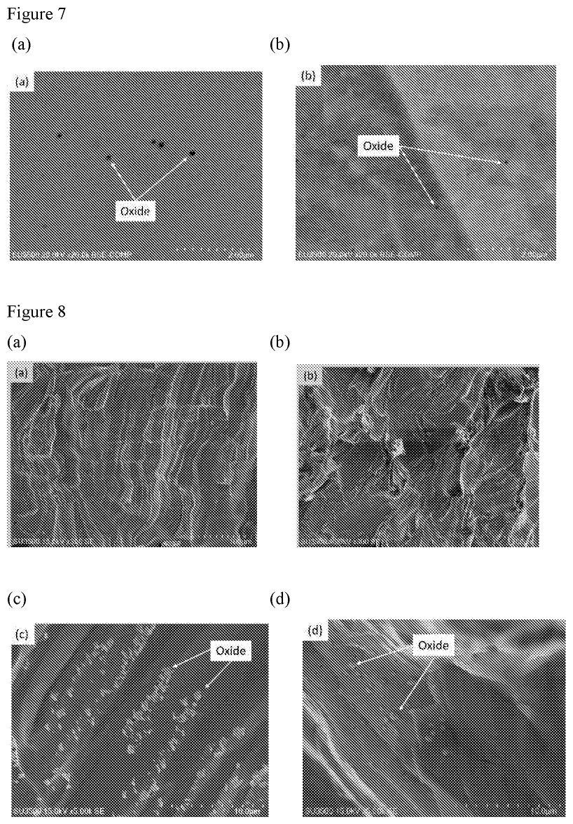

FIG. 7 shows SEM micrographs of oxide particles in (a) Mo—Ar, and (b) Mo—N;

FIG. 8 shows SEM fractographs (a, c) Mo—Ar, and (b, d) Mo—N, with (c, d) high magnification SEM showing oxide particles;

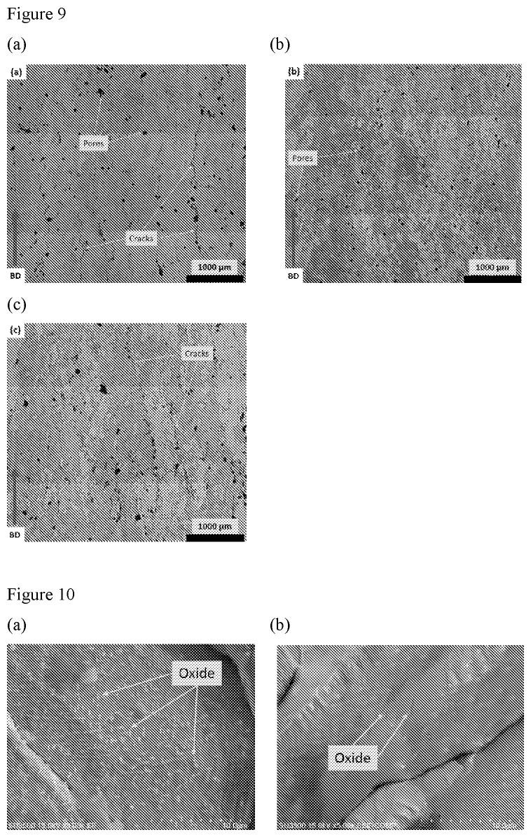

FIG. 9 shows the structure of (a) W—Ar built on a W plate, (b) W—N built on a W plate, (c) W—N built on a steel plate;

FIG. 10 shows a comparison of fracture structure for builds carried out in (a) an Argon atmosphere, and (b) a Nitrogen atmosphere.

FIG. 11 shows how ductility of various metals including Molybdenum and Tungsten changes with temperature;

And

FIG. 12 shows microhardness analysis for a Mo part for various concentrations of nitrogen in the protective atmosphere.

FIG. 1 schematically shows the SLM process and apparatus. The apparatus comprises a ytterbium fibre laser 1, which emits a laser beam 3. One or more scanning mirrors 2 serve to direct the laser beam 3 on to the powder. The powder is provided on a base plate 4 which can be moved up and down by operation of a piston 5. A powder deposition or recoating mechanism 7 for depositing the powder in layers during the SLM process comprises a wiper blade 6.

In use, powder layers are uniformly spread on a substrate provided on the base plate 4 using the powder deposition mechanism 7. Each layer is scanned with the ytterbium fibre laser beam 3 (wavelength (λ)=1.06 beam spot diameter=80 μm) according to CAD data. The melt powder particles fuse together (a solidified portion is indicated at 8), forming a layer of the article or part, and the process is repeated until the top layer. The article or part is then removed from the substrate and any unfused powder can be reused for the next build. Typically, the process is performed under a protective environment while the oxygen level is typically vol %. During the SLM process, the chamber atmosphere, which is kept at an overpressure of 10-12 mbar, is continuously recirculated and filtered.

The input data for making a part comprise geometrical data stored as a CAD file and the laser scanning process parameters. The main process parameters which may affect the density of aluminium SLM parts include: laser power; the laser scanning speed which depends on the exposure time on each of the laser spots that constitute the scanned path, and the distance between them (point distance); and the distance between the laser hatches.

FIG. 2 illustrates some of the main laser scanning parameters. The arrows indicate a laser scanning pattern across a sample. FIG. 2 shows a boundary 21, inside which there is a fill contour 22. A fill contour offset 27 constitutes the distance between the boundary 21 and the fill contour 22. The laser scanning pattern covers substantially all of the sample within the fill contour 22. The laser scanning pattern constitutes a path (indicated by the arrows) made up of a series of laser spots. For illustrative purposes a few of these laser spots are shown individually in the top line of the laser scanning pattern. The distance from a given laser spot to the next laser spot in the sequence is known as the point distance 23. Each line within the laser scanning pattern is known as a hatch 24. The laser scanning pattern illustrated in FIG. 2 comprises 17 substantially parallel hatches; the laser scans in a first direction along a first hatch, then in a second opposite direction along a second hatch, then in the first direction along a third hatch, then in the second opposite direction along a fourth hatch and so on. The distance from an end of a hatch 24 to the fill contour 22 is known as the hatch offset 26. The distance between one hatch and the next hatch in the sequence, e.g. between a sixth hatch and a seventh hatch, is known as the hatch distance 25.

Gas atomized Molybdenum (Mo) powders (chemical composition shown in Table 1) of size between 15-45 μm procured from Tekna® were used in this study. Scanning Electron Microscope (SEM) characterization was performed on the powders using an SU3500 (Hitachi®) SEM. Particle size distribution (PSD) was measured using LA-920 laser particle size analyser (Horiba®). Each of these tests were conducted three times, in order to obtain statistical significance of the reported values. Flowability of the powders were tested using Hall and Carney funnel methods as per ASTM B213 and B964, and using the rotating drum apparatus (GranuDrum®).

TABLE 1
Composition of Mo powders used in this study as per the
certificate of conformity

| Element | Mo | Cr | Fe | Ni | C | O | N | H | Others |
|---|---|---|---|---|---|---|---|---|---|
| Wt. % | 99.98 | <0.01 | <0.01 | <0.01 | <0.005 | 0.016 | <0.01 | <0.002 | <0.01 |

LPBF was performed on an AM400 LPBF machine (Renishaw®) equipped with a reduced build volume (as described in WO 2016/055523). Samples were fabricated with identical parameters under two different atmospheres: argon (Ar) and nitrogen (N₂), both with purity of 4.8 HP (99.998% High Purity, Praxair®) using zigzag scanning pattern and 67° rotation between each layer. Oxygen was limited to less than 300 ppm in either build atmospheres. Mo (99.95% metals basis) plates of 2.5 mm thickness from Alfa Aesar® were used as substrates.

Samples were sectioned for characterization using an IsoMet™ Low Speed Precision Cutter (Buehler®). Metallographic preparation was performed by grinding up to 800 grit SiC paper, then polishing with diamond suspensions of 9 μm, 3 μm, and 1 μm size particles, followed by 0.05 μm colloidal silica suspension on a Labopol (Struers®) equipment. Optical micrographs to characterize build microstructure, density and crack defect structure, were captured using a light optical microscope (Nikon®) equipped with a Clemex Vision System (Clemex®). Average crack length was calculated as the ratio of the cumulative crack length in a sampling to the number of cracks, and crack density was calculated as the ratio of the cumulative crack length within a 1 mm² area divided by the average crack length calculated earlier using Fiji® distribution of ImageJ software (J. Schindelin, I. Arganda-Carreras, E. Frise, Fiji—an Open Source platform for biological image analysis, Nat. Methods. 9 (2012) 676-682. doi:10.1038/nmeth.2019.Fiji).

Crystallographic texture and grain morphology were studied using an SU3500 SEM equipped with an electron back-scattered diffraction (EBSD) detector (Oxford Instruments®). HKL Channel 5 software (Oxford Instruments®) was used for analysis of the EBSD data. The grain diameter was measured as equivalent circle diameter, and the local misorientation profile was evaluated using line maps of length equal to 80% grain diameter. High magnification electron micrographs for precipitate characterization were captured using an SU9000 (Hitachi®) field emission scanning electron microscope (FE-SEM) equipped with an energy dispersive spectrometer (EDS) detector (Oxford Instruments®).

The SEM micrographs of the Mo powder used in this study is shown in FIG. 3. The powders are spherical in nature, without any satellites or agglomeration. The results of Hall and Carney flow tests showed flow times of 13.16±0.05 s (per 50 g) and 6.20±0.01 s (per 150 g) respectively, indicating high flowability. The apparent density of the powder was measured to be 57±1%.

The powders showed a narrow PSD, as depicted in FIG. 4a, with D₁₀, D₅₀ and D₉₀ values of 20±2 μm, 29±2 μm, and 43±3 μm respectively. FIG. 4b shows a representative result of the rotating drum experiment, plotting the relationship of cohesiveness index with respect to rotational speed. The cohesiveness index values are well below the critical value of 24 suggesting easy spreading during re-coating, thus regular recoating speed could be used.

FIG. 5 shows optical and EBSD micrographs of the cross-section (BD indicates the build direction) of the samples fabricated under Ar atmosphere (Mo—Ar) are shown in FIGS. 5a and 5b, respectively. The optically measured density of sample was 98.7±0.4%. For the Mo—Ar sample cracks were observed along the grain boundaries, and mostly aligned with the build direction. The Mo—Ar sample showed an average crack length of 632±41 μm, with a crack density 4.8±0.3 per mm² with very few cracks with lengths above 1 mm.

FIGS. 6a and 6b respectively show the optical and EBSD micrograph of the samples fabricated under N₂ (Mo—N) atmosphere. In contrast to the Mo—Ar samples, the Mo—N samples did not show any cracking. The optically measured density of the Mo—N sample was 99.1±0.1%. In the Mo—N sample, the grain structure shows limited columnar nature, and along the build direction, grains are disrupted by melt-pool like boundaries. Except for some grains with large columnar structure, majority of the grains are larger in width than their height with an aspect ratio (H/W) ranging between 0.8 and 1.3. Similarly, most of the grains showed a grain diameter between 6 to 20 μm, with a few grains of larger grain diameter. The misorientation angle for α-Mo grain boundaries in Mo—N sample was measured at 30.1±2.1°, while the same between two small grains with precipitates show a higher value of 48.3±3.7°. This is proposed to be due to the influence of nitride precipitates in the Mo—N samples which cause a greater misorientation and presence of sub-micron sized sub-grains within the alpha-Mo grains.

The results obtained suggests that the presence of nitrogen as interstitial is reducing the deleterious interactions between oxygen and Mo. FIGS. 7a and 7b are SEM micrographs of Mo—Ar and Mo—N samples describing the oxide particles as dark round artefacts in these respective samples. The Mo—Ar sample showed a higher area fraction of oxides at 0.35%, with average diameter of 0.152±0.024 μm, while Mo—N sample showed a lower area fraction of 0.12% with an average diameter of 0.082±0.017 μm.

The proposed mechanisms for N₂ dissolution in Mo during LPBF processing starts from adsorption at the surface, followed by diffusion into the liquid. The dissolved N is expected to either leave the Mo as gas, develop internal porosity, be trapped as interstitial in the Mo lattice or be reacting with Mo to form precipitates.

Fracture surface SEM micrographs obtained from uncontrolled cracking of the samples are shown in FIGS. 8a and 8c for Mo—Ar sample. The fracture surface features are suggesting crack propagation at grain boundaries for the Mo—Ar samples. Higher magnification micrograph as seen in FIG. 8c indicates large number of irregular oxide particles at most of the grain boundaries in the sample. The surface is indicative of the grain morphology as seen from EBSD analysis earlier. FIGS. 8b and 8d respectively show the fracture surface micrographs of Mo—N sample, with indications of intragranular fracture. In stark contrast to Mo—Ar samples, Mo—N indicated fewer and smaller round precipitates at very few locations. In the Mo—N sample extensive grain boundary search was needed to identify some or any oxide particles.

It is theorised that by performing LPBF of molybdenum in a nitrogen atmosphere, nitrogen is introduced into the molybdenum which reduces the solubility of oxygen in the melt pool. This results in reduced oxide content within the part, particularly at grain boundaries, leading to greater grain boundary strength. Cracking can be significantly reduced and even substantially eliminated without significantly affecting the purity of the part.

FIG. 12 shows microhardness analysis for a molybdenum part for various compositions of the protective gas. The protective gas used during part formation was a mixture of nitrogen and argon (with the exceptions of 100% nitrogen and 0% nitrogen (100% argon)), the figure showing the percentage of nitrogen on the x-axis (with the remainder being argon). As can be seen from the figure when the protective gas has a composition by volume of 60% nitrogen and 40% argon an increase in hardness of the part is observed compared to a protective atmosphere of 100% argon (0% nitrogen).

Tungsten (W) powders having a purity of 99.98% procured from Tekna® were used in a further study. LPBF was performed on an AM400 LPBF machine (Renishaw®) equipped with a reduced build volume (as described in WO 2016/055523). Samples were fabricated with identical parameters under two different atmospheres: argon (Ar) and nitrogen (N₂), both with purity of 4.8 HP (99.998% High Purity, Praxair®) using zigzag scanning pattern and 67° rotation between each layer.

The powders showed a PSD having D₁₀, D₅₀ and D₉₀ values of 21.19 μm, 30.65 μm, and 44.72 μm respectively and an apparent density of 58.4% of theoretical density. Hall and Carney flow tests showed flow times of 5.00 s (per 50 g) and 2.10 s (per 150 g) respectively.

FIG. 9 shows optical analysis of various builds using Tungsten powder, in the figure BD denotes build direction. FIG. 9(a) shows a Tungsten build built on a Tungsten plate in an Argon atmosphere, FIG. 9(b) shows a Tungsten build carried out on a Tungsten plate in a Nitrogen atmosphere, and FIG. 9(c) shows a Tungsten build carried out on a steel plate in a Nitrogen atmosphere. Analysis of the figures shows that for the build carried out on a Tungsten plate in an Argon atmosphere (FIG. 9(a)) the part density (%) was 98.03, crack density (/mm²) was 1.2±0.2 and average crack length (μm) was 1209±233. For both builds carried out in a Nitrogen atmosphere, improved properties were found. For the Tungsten build carried out in a Nitrogen atmosphere on a steel plate (FIG. 9(c)) the part density (%) was 98.28, crack density (/mm²) was 0.5±0.2 and average crack length (μm) was 671±108, while the Tungsten build carried out in a Nitrogen atmosphere on a Tungsten plate (FIG. 9(b)) the part density (%) was 99.00, and no cracks were found in the sample demonstrating a significant improvement.

FIG. 10 shows a comparison of fracture structure for builds carried out in (a) on a Tungsten plate in an Argon atmosphere, and (b) on a Tungsten plate in a Nitrogen atmosphere. As can be seen W—Ar samples show large number of oxide particles at the fracture surface in comparison to the few visible particles in the case of W—N sample.

It appears that just as it was theorised that by performing LPBF of molybdenum in a nitrogen atmosphere reduces the oxide content within the part, the same is true for Tungsten. By introducing nitrogen into the Tungsten melt pool reduces the solubility of oxygen in the melt pool. This results in reduced oxide content within the part, particularly at grain boundaries, leading to greater grain boundary strength. Cracking can be significantly reduced and even substantially eliminated without significantly affecting the purity of the part. It is noted that both tungsten and molybdenum are in the same group in the periodic table (group VIB) and have a BCC crystal structure.

The same process of performing LPDF of molybdenum and tungsten in a nitrogen atmosphere to reduce the oxide content within a part is also possible in chromium, due to chromium being in the same group of the periodic table. Processing chromium and chromium alloy powders using LPBF is theorised to reduced oxide content within the part, particularly at grain boundaries, leading to greater grain boundary strength. Cracking may be significantly reduced and even substantially eliminated without significantly affecting the purity of the part. It is noted that chromium is also in group VIB of the periodic table and has a BCC crystal structure.

1. A method of producing a workpiece comprising molybdenum, or tungsten, or chromium, or molybdenum alloy, or tungsten alloy, or chromium alloy by selective consolidation of successive layers of powder by an energy beam, the method comprising performing the selective consolidation of the powder layer in a protective atmosphere comprising nitrogen.

2. A method according to claim 1 wherein the oxygen concentration in the protective atmosphere is less than 1000 ppm.

3. A method according to claim 1 wherein powder layer is preheated to a maximum temperature not exceeding the ductile to brittle transition temperature of the powder.

4. A method according to claim 1 wherein powder layer is preheated to a maximum temperature not exceeding 400° C.

5. A method according to claim 1 wherein powder layer is preheated in the range 80° C. to 400° C.

6. A method according to claim 5 wherein powder layer is preheated in the range 80° C. to the ductile to brittle transition temperature of the powder.

7. A method according to claim 1 wherein the protective atmosphere comprises at least 5% Nitrogen by volume.

8. A method according to claim 1 wherein the protective atmosphere comprises a further protective gas.

9. A method according to claim 8 wherein the further protective gas comprises Argon and/or Helium.

10. A method according to claim 9 wherein the further protective gas comprises Argon and wherein the protective atmosphere comprises at least 5% Argon by volume.

11. A method according to claim 9 wherein the further protective gas comprises Argon by volume in the range of 5% to 40%.
